(19) United States
(12) Patent Application Publication
(10) Pub. No.: US 2021/0176678 A1
(43) Pub. Date: Jun. 10, 2021

(54) METHOD AND APPARATUS FOR RADIO RESOURCE EVALUATION AND MANAGEMENT, DATA MEMORY, DATA CARRIER

(71) Applicant: GUANGDONG OPPO MOBILE TELECOMMUNICATIONS CORP., LTD., Dongguan, Guangdong (CN)

(72) Inventors: Jari Jaakko ISOKANGAS, Tampere (FI); Ning YANG, Dongguan, Guangdong (CN); Yixue LEI, Dongguan, Guangdong (CN)

(73) Assignee: GUANGDONG OPPO MOBILE TELECOMMUNICATIONS CORP., LTD., Dongguan, Guangdong (CN)

(21) Appl. No.: 16/760,872

(22) PCT Filed: Nov. 1, 2018
(86) PCT No.: PCT/CN2018/113537

§ 371 Date: Apr. 30, 2020

Related U.S. Application Data
(60) Provisional application No. 62/580,202, filed on Nov. 1, 2017.

(51) Int. Cl. H04W 36/00; H04W 74/08; H04W 36/08; H04W 36/22

(52) U.S. Cl. CPC H04W 36/0077; H04W 74/0833; H04W 36/00837; H04W 36/22; H04W 36/08

(57) ABSTRACT

A method for comparative radio resource evaluation comprises the steps of assessing quality metrics of dedicated RACH resources carried by a beam and assessing quality metrics of common RACH resources carried by a beam, comparatively evaluating said assessed quality metrics of said resources, and storing or transmitting the comparative evaluation result or taking further measures in accordance with said comparative evaluation result.

### PRIOR ART

In modern cellular systems, like LTE LTE-A (Long Term Evolution, Long Term Evolution Advanced) and 50 NR (5th generation New Radio) in the future, a handover procedure is used to disconnect a user equipment (UE) from the currently used radio resources of the current (serving) network node and to connect UE with new radio resources from new (target) network node.

Before UE can start using new radio resources allocated from target network (NW) node, synchronization and random-access procedures are needed. After UE has been synchronized with target NW node, it is able to receive and transmit bits between itself and the NW node. It then can start the random access procedure towards the target cell.

A random access procedure on a random access channel (RACH) after synchronization can be either contention based or contention free, depending on whether common or dedicated RACH resources are used for the access procedure. The Physical RACH (PRACH) resources are identified by time (subframe), frequency and preamble sequence. Common PRACH resource configuration is broadcasted in each cell using system information messages, e.g. system information blocks (SIB) SIB1 or SIB2, and these broadcasted resources can be used by any UE which tries to access to the cell. According to simple statistics this will lead to a situation where several UEs select same PRACH resources for accessing the target cell such that there will be a competing situation between UEs using same resources. If several UEs try to access with same PRACH resources, one will succeed and others need to select new resources and try again.

During the handover procedure, it is also possible that the target NW node provides dedicated PRACH resource configuration to certain UE to be used for a contention free access. This should allow faster and more reliable access to the target cell.

In LTE and LTE-A the dedicated PRACH configuration during handover procedure is provided on cell level. The target cell has been selected by the target NW node based on UE radio resource management (RRM) measurements.

In 5G NR, the PRACH configuration can be provided on beam level. One beam used in 5G NR could cover areas much smaller than a cell, and in one cell there can be several transmission points (TRP), and one TRP can handle several beams. Accordingly, under LTE and LTE-A, several dedicated PRACH resources need to be provided to the UEs during handover procedure.

One approach is that the targeted next generation NodeB (gNB) can allocate to beam level dedicated RACH resources which are associated either with synchronization signal (SS) blocks (SSB) or with a Channel State information Reference Signal (CSI-RS), and this dedicated RACH resource information (configuration) can be passed to UE in Handover Command message (RRCConnectionReconfiguration) according to TS 36.331 and TS 38.331 during the handover procedure, see also TS 38.300. Target gNB should also include common RACH resource configuration valid for accessing to the target cells.

The paper “Discussion on how the dedicated RACH resources should be prioritized”, 3GPP TSG RAN WG2 #99bis R2-1711766, published in conjunction with the 3GPP TSG RAN WG2 #99bis meeting in Prague, Czech Republic, 9-13Oct. 2017, proposes that in 5G NR a UE should keep on measuring the beam quality to verify whether the dedicated RACH resources is suitable after receiving the HO command. UE should attempt the suitable dedicated RACH, and UE should fall back to use common RACH resource only if there are no suitable dedicated RACH resources.

It is thus proposed that UE prioritizes suitable beams with dedicated PRACH resources, if configured, over common PRACH resources. A suitable beam is defined as a beam that (a) is identified either with SSB or CSI-RS, (b) has dedicated RACH resources allocated and (c) has measured beam quality, such as reference signal received power value (RSRP) and/or reference signal received quality value (RSRQ) above the threshold value indicated by the NW in a handover (HO) command message. It is considered that, as long as there is any suitable beam with dedicated resources available, UE is not allowed to access with common resources.

However, as the radio condition could change quite rapidly, especially in small cell environment due to beam sweeping and UE mobility, it cannot be assured that it would always be beneficial for UE or even the entire network trying to access the target cell only with beams with dedicated resources. The RRM conditions could have changed after dedicated resources were allocated. And even if the quality level is still above the threshold, there could be other beams which have significantly better quality than beams with dedicated resources so that strictly using beams with dedicated resources may not always be the most effective approach in view of network resource consumption, latency and the like. For example, just after the handover additional beam/cell change can occur, for example when UE is moving away from beams with dedicated resources.

In that case it is quite likely that UE need to perform another beam/cell change immediately after HO to a beam with dedicated resources has been finalized. These additional beam/cell changes would lead to decreased end user and system performance.

More generally speaking, there is a need for comparatively evaluating quality of dedicated RACH resources vs. quality of common RACH resources. This may be desired, for example, for obtaining meaningful network statistics or for providing adaptive network settings. Accordingly, also without the particular target of managing a handover, the quality relation amongst dedicated and common RACH resources is of interest.

### SHORT DESCRIPTION Of THE INVENTION

It is the object of the invention to provide a radio resource evaluation method capable of providing a flexible and adapted comparative evaluation of dedicated and common RACH resources.

This object is accomplished by the features of the independent claims.

A method for comparative radio resource evaluation in mobile telecommunication comprises the steps of assessing quality metrics of dedicated RACH resources on a radio beam and of common RACH resources on a radio beam, using said assessed quality metrics in a comparative evaluation and storing or transmitting or further using the comparative evaluation result.

The comparative evaluation may comprise forming an actual difference and/or ratio amongst said assessed quality metrics and comparing said actual difference and/or ratio with one or more threshold values. Said actual difference and/or ratio may be seen as, and called, an actual quality offset amongst said assessed quality metrics. The one or more threshold values may be seen as, and called, a set quality offset metrics.

The method may further comprises obtaining a set quality offset metrics, making a second determination if the second quality metrics exceeds the first by at least said set quality offset metrics, and otherwise making a first determination. Said determinations may simply be to store or transmit the respective evaluation result and possibly related data as a data tuple (such as first and/or second quality metrics, their actual offset and/or the obtained set quality offset metrics, date, time location, possibly associated network settings) for later evaluation, or to use the obtained data for further measures or procedures such as determining network statistics, setting, network configuration parameters managing handovers or the like.

A corresponding apparatus for comparative radio resource evaluation is also provided.

Quality metrics of dedicated or common RACH resources may be quality metrics of the radio beams carrying these resources.

Looking at a handover, it would be beneficial to allow a UE in the course of beam change and/or cell change to access the target NW also through beams with common resources in certain cases, to ensure best available service level just after the handover and to avoid unnecessary additional beam/cell changes which can occur especially when UE is already moving away from beams with dedicated resources. The “certain cases” may be situations in which both dedicated and common RACH resources are available, possibly carried by different beams, and the signal quality of a beam without dedicated resources (i. e. with common RACH resources) is significantly higher than that of a beam or beams with dedicated resources. It may also be a case where it is known that a UE moves out of the reach of a beam with dedicated resources.

A method for radio resource management for a handover procedure towards a target node in mobile telecommunication comprises the steps of determining whether to use in a radio handover procedure a radio beam carrying dedicated RACH resources or a radio beam carrying common RACH resources and selecting and using a beam in accordance with said determination. Making said determination comprises assessing a first quality metrics of dedicated RACH resources on a first beam, assessing a second quality metrics of common RACE resources on a second beam, obtaining a set quality offset metrics equal to or larger than zero, determining to use the second beam if the second quality metrics exceeds the first by at least said set quality offset metrics, and otherwise determining to use the first beam.

In this way, it is ensured that, on the one hand side, the first beam with dedicated RACH resources is prioritized, but that under certain conditions the second beam carrying common RACH resources may nevertheless be used.

As said above, the selection amongst the mentioned beams is made in accordance with quality considerations. It is pointed out insofar that these quality considerations may consider technical aspects such as signal strength and signal quality. But they may consider also other quality aspects such as organizational or service qualities, such as expected lifetime and the like. Expected lifetime may consider that, for example, it is likely that a UE will soon leave the reach of a target beam in view or its movement pattern or the like. Accordingly, the quality considerations mentioned above may consider both technical qualities and kind of organizational or administrative qualities as far as they are known or can be captured for example by statistical considerations with reasonable reliability.

The dedicated RACH beam is prioritized over the common RACH beam in that the quality comparison amongst the resources is not the direct criterion for deciding amongst them. Rather, a set quality offset amongst them is defined, and the common resources RACH beam is selected only if its quality exceeds the quality of the dedicated resources RACH beam by at least said set quality offset. This ensures that UES are only exceptionally directed to common resources RACH beams and thus are not systematically led into contention-likely situations when competing for a common resources RACH beam.

As long as no specific determination as described above was made, a default determination may be to use the first beam so that again a beam with dedicated RACH resources is prioritized.

The set quality offset metrics may be a system parameter preferably given or determined independent of the relation amongst the actually assessed quality metrics. It may be a predetermined absolute value or a predetermined value relative to one of the first or the second quality metrics or it may be determined in accordance with own criteria in accordance with technical and/or organizational system parameters and/or the like.

By appropriately setting the set quality offset metrics, it can be controlled to which extent messages are diverted towards common RACH resources beams. Depending upon circumstances, the value can be made fix or relative or can be determined in accordance with suitable criteria such as load conditions, channel conditions and the like.

The set quality offset metrics may be fix and may then be stored in a user equipment for use there. But likewise, it can be determined elsewhere, for example in a base station or node and can be communicated to the UE. It may then be communicated together with RACH configuration information, preferably in a handover command message, and/or in a broadcast system information message.

If the set quality offset metrics is determined in a node or at other nearby terrestrial network components, circumstances can be considered that are unknown to the UE, such as network traffic and the like.

Generally speaking, the set quality offset metrics may be a positive or a negative value or may be zero. Its value may be subject to, and changed by, adaptive network management procedures. Technical and/or administrative and/or business aspects may contribute to setting and changing the set quality offset metrics, thus taking direct or indirect influence on load balancing amongst common and dedicated RACH resources.

The first and/or second quality metrics can be a S/N ratio. It is pointed out here that also other quality considerations, such as those mentioned above, can be computed into an equivalent S/N value and can be computed into a single metrics reflecting all desired factors, i. e. technical, organizational factors and the like.

But instead of S/N values, also other suitable quantifications can be used, such as signal strength.

The first quality metrics may be assessed from synchronization signal blocks and/or from general state information reference signals. Since these values should be subjective for the respective user equipment, the related determinations of the quality metrics can be made in the respective UE. The UE receives the mentioned signals and determines the mentioned metrics from the received signals.

Particularly, when determining the first and/or second quality metrics of the related resources or beams, it may also be assessed in accordance with a movement of the concerned UE. Movement of UE may be known in terms of speed and direction, and it may thus be known when the UE leaves the related beam. If it turns out that there is only a relatively short remaining duration, this can be seen as a kind of degraded service/organizational quality because soon a further change is likely, and may be computed into an overall quality metrics of the related resource or beam. Then, the respective quality metrics of the respective resources or beams does not only reflect present instantaneous technical circumstances such as signal strength and signal quality, but also kind of organizational circumstances and the like.

Regarding technical circumstances, the quality metrics of at least one or of both resources (dedicated vs. common RACH resources) or beams to be compared can be obtained in accordance with a reference signal received power value and/or in accordance with a reference signal received quality value. Then, also technical considerations are properly reflected by the obtained quality metrics.

Assessing the first quality metrics and/or the second quality metrics may be made selectively by one of a plurality of available methods. A corresponding plurality of available set quality offset metrics may be provided, one of them being selected corresponding to the selection of the quality assessment method. By such an arrangement, it can be ensured that a suitable quality assessment method can be selected. Different quality assessment methods may be RSRP measurement, RSRQ measurement, and/or others. Corresponding set quality offsets can then be provided and selected corresponding to the selection of RSRP, RSRQ or others.

Altogether, the method is configured in accordance with 5G NR specifications and is configured to operate in a 5G NR framework. Particularly, it relates to a handover, e.g. during a beam change, preferably in conjunction with a cell change, that may be initiated by a node. The handover itself, after having been commanded, may start with a synchronization of the user equipment (UE) with the related node. A system information download to the UE may follow for learning settings on the various levels of the applying protocols. Then, a RACH procedure may follow. In this context, the mentioned question of utilizing a beam carrying dedicated RACH resources or a beam carrying common RACH resources arises when both of them are available and is addressed as mentioned above. After completion of the RACH procedure, which may include contention resolution, the new connection setup is completed.

The determination as to whether a common RACH resources beam or a dedicated RACH resources beam is to be used can be made in the UE according to the mentioned criteria. It is adapted to obtain the required values, particularly the mentioned quality metrics and the set quality offset, and to make the determination as mentioned. But likewise, the UE may receive only an indication on said determination from external, wherein the determination itself was made external. The UE then stores the related indication and uses it when necessary.

Also, the quality assessments of the various resources can be made in the UE or elsewhere and can, if required, be communicated amongst entities as required, particularly when required for making the mentioned determination. Finally, also the set quality offset metrics can be determined in the if according to certain criteria, or can be received by the UE and stored there to be used when required.

The comparative evaluation or determination can be made upon actual necessity in the course of an actual handover. But likewise, it could be made in advance to be immediately available when required later. If made in advance, its result can be stored ready for use. Thus, triggering, the determination can be made by a received or issued handover command, or can be made precautionary for example periodically or triggered by certain system states or events, such as changing position, changing radio parameters, reconfiguration with sync or the like.

According to the invention, also an apparatus for comparative radio resource evaluation and/or for radio resource management is devised. In one aspect it can be seen as an apparatus implementing the above described method in the various options.

An apparatus for a radio resource management comprises generally determining means for determining whether to use in a beam change or cell change in a random-access procedure a dedicated RACH resources beam or a common RACH resources beam. It also has selecting means for selecting a beam in accordance with said determination. The determination means comprises first assessing means for assessing a first quality metrics of dedicated RACH resources on a first beam, second assessing means for assessing a second quality metrics of common RACH resources on a second beam, obtaining means for obtaining a set quality offset metrics larger than zero, and deciding means for determining to use the common RACH resources beam if its quality metrics is higher than, and offset from the quality metrics of the dedicated RACH beam by at least the set quality offset. Otherwise, using the dedicated RACH beam is decided.

It is pointed out that the mentioned apparatus may be a distributed apparatus in which different components are located in different physical entities, and required values are communicated. Particularly, the apparatus may be distributed between a UE and stationary components, such as a stationary node or more remote stationary to components. If distributed, the required information interchange is provided for supplying the required information appropriately. But likewise, the apparatus may be a standalone device, such as the UE making the mentioned quality assessments and having a pre-stored or determined set quality offset metrics.

One part contributing to the implementation of the described method or is apparatus will be appropriately written computer code. Accordingly, part of the invention is a data carrier holding executable code which, when running, implements the above-mentioned method or implements the above-mentioned apparatus.

Further, an aspect of the invention is for it alone the mentioned set quality offset metrics and a memory holding it. Accordingly, also a memory element holding the set mentioned quality offset metrics and adapted to receive and release it as required by the mentioned method or apparatus is part of the invention. Depending on implementation details, such a memory element may be in a UE or in a stationary device, such as a node or the like, or in both.

### BRIEF DESCRIPTION OF THE DRAWINGS

In the following, further aspects of the invention will be described with reference to the attached drawings.

FIG. 1 is a plan view on a radio cell in a certain physical layout.

FIG. 2 is a flow diagram of a method.

FIG. 3 shows a map on possible relations amongst assessed quality metrics and a set quality offset.

### DETAILED DESCRIPTION

In the following, features and aspects of the invention are described also in relation to a handover procedure. However, as far as possible, these features shall also be understood as being useful or used in a broader comparative radio resource evaluation technique independent of handovers. In an embodiment, the latter may be understood as a preparatory stage of the former.

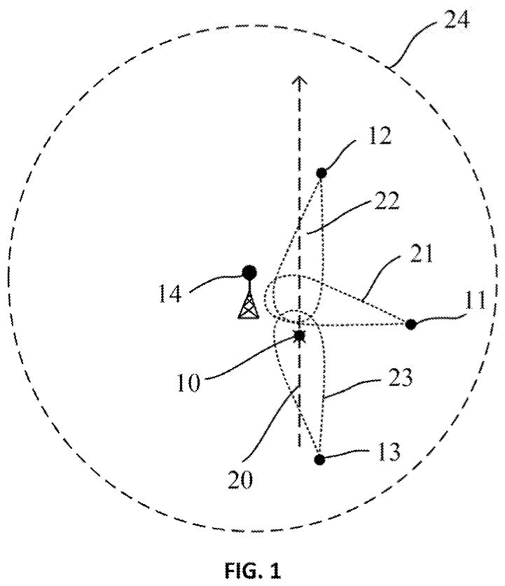

FIG. 1 shows a scenario in a plan view in which the invention exhibits its effects. It can be understood as a plan view of a cell. In the cell are various nodes 11, 12, 13, 14. Some or all of them may be stationary. Nodes 11, 12 and 13 are adapted to send out beams 21, 22, 23, i.e. directed radio transmission, whereas node 14 sends undirected as indicated by dashed circle 24, called “broadcast”. 10 indicates a UE having or requiring radio connection to the network. 20 indicates its trajectory.

A skilled person understands that the shown boundaries of beams 21, 22, 23 and broadcast 24 of the various covered regions are not hard boundaries but can be understood as kind of thresholds in which reasonable radio quality can be expected.

It is assumed that user equipment (UE) 10 is about to leave beam 23 and would get into the reach of beams 21 and 22. It is further assumed that beam 21 has dedicated RACH resources, whereas beam 22 has common RACH resources. In the shown arrangement the situation is such that UE 10 will briefly cross beam 21 and will remain longer time in beam 22. A handover is imminent as UE 10 is about to leave beam 23, The presently serving node 13 can initiate the handover, acting as a source node. It may be a gNB (“next generation nodeB”). The same applies to nodes 11 and 12.

After in initiation/commanding, a synchronization and information procedure may follow for providing UE 10 with relevant information and synchronizing it with a potential target node, which may again be a gNB, such as node 11 or node 12.

After synchronizing and informing, a determination follows as to which of the beams 21 or 22 from nodes 11 or 12 to use.

In the following, node 11 will be addressed as “first node”, node 12 will be addressed as “second node”. Beam 21 will be addressed as “first beam”, beam 22 will be addressed as “second beam”.

A default setting may be that UE 10 selects first beam 21 because it has dedicated RACH resources. But irrespective of such a potential default setting, a decision procedure amongst first beam 21 and second beam 72 may follow.

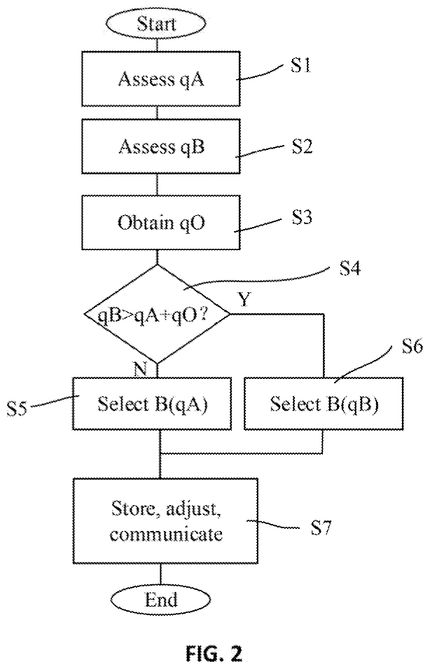

The related method steps are schematically shown in FIG. 2. After initiation of the determination procedure, in step S1 the quality qA of the first beam 21 with dedicated RACH resources is assessed. This may be made by one of the above-mentioned methods.

In step S2, the quality metrics qB of a resource on the second beam 22 is assessed. Again, this assessment may be made in accordance with the mentioned methods and aspects.

As said earlier, the quality assessments for quality metrics qA and qB may include technical aspects and organizational aspects in the sense of technical quality and organizational quality. In the scenario shown in FIG. 1, the second beam 22 has the organizational advantage over beam 21 that UE 10 will most likely remain longer in beam 22 than in beam 22 because beam 22 covers more of a predicted trajectory. Accordingly, regarding quality assessment, on the one hand side the technical aspects can be quantified. But likewise, organizational aspects as mentioned above can be quantified. The various individual quantifications can finally be integrated into one particular quality metrics in an agreed format.

The two quality metrics qA and qB are determined, possibly after suitable conversion/s, in a comparable format/coding. For example, they may be expressed as a signal-to-noise ratio (S/N ratio). It is to be understood that if other than technical aspects are computed into the quality metrics, the numeric format may be that of a S/N ratio, but the number is a summarizing container of various aspects.

In step S3, a set quality offset qO is obtained. It may a predetermined and prestored value, or it may be an up-to-date determined value. It may be a fixed, constant value or may be a relative value relative to qA or qB. In its format, possibly after a conversion, it is comparable to the metrics qA and qB. The set quality offset metrics qO may be held locally and retrieved from a local memory cell or may be received from external and may temporarily be stored as long as needed.

It is pointed out that the order of steps S1, S2 and S3 as shown in FIG. 2 is not compulsory. The order amongst these steps may be different.

Once the mentioned metrics qA and qB and the set offset qO are available, it is determined whether the quality metrics qB relating to the common RACH resources second beam 22 exceeds the quality of the dedicated RACH resources first beam 21 by at least the set quality offset metrics qO. This determination is made in step S4. The query of step S4 can be expressed as the following formula:

qB>qA+qO

or re-written into

qB−qA>qO

If it is found that the quality metrics qB of the common RACH resources beam 22 exceeds the quality metrics qA of the dedicated RACH resources beam 21 by at least the set quality offset metrics qO (“yes” in S4) the second beam 22 with common RACH resources corresponding to quality metrics qB is selected for use. Otherwise, the first beam 21 with quality metrics qA and dedicated RACH resources is selected. These selections are made in steps S5 and S6, respectively, by generating a corresponding marker and/or by making right away the required settings for using the respective beam. The selection made in these steps S5, S6 will overwrite former selections or potential default settings.

Instead of a difference qB−qA of the assessed metrics also their ratio qb/qA can be used. The set quality offset metrics qO is then adapted to such another relation. It may be 1 or larger than 1.

In step S7, the selection can be stored as a related marker. If to be used immediately, the radio hardware can adjust to the selection and adjust to the selected beam. Likewise, if the selection is to be made elsewhere, the selection result can be communicated.

In actual use, the determination made amongst first and second beams 21 or 22 leads to the selected beam 21 or 22 being used for the following RACH procedure. It may also be used thereafter. This is per se known and will not be described here.

As said earlier, the flow shown in FIG. 2 may be triggered by a handover command relating to an imminent handover or may be triggered by other circumstances in a kind of precautionary manner.

It is preferred that the quality metrics assessments in relation to metrics qA, qB in steps S1 and S2 are made in UE 10 because UE 10 sees the true and actual radio situation.

Obtaining the set quality offset qO in step S3 may be as simple as reading a memory cell bolding a predetermined and prestored value. But likewise, it may be more complex. The set quality offset qO may, for example, be set in accordance with changing network policies, load balancing requirements and the like. It may be determined in a stationary device having knowledge of such requirements and may then be communicated to a deciding entity such as UE 10. Vice versa, UE 10 may perform the assessments of steps S1 and S2 and may communicate the results to a stationary device.

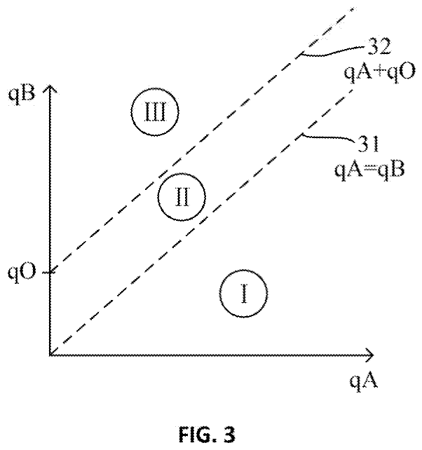

FIG. 3 shows the relation amongst the quality metrics qA, qB and the set quality offset metrics qO. The abscissa shows quality metrics qA of the beam with dedicated RACH resources or of the resource on that beam, the ordinate shows metrics qB of the beam with common RACH resources or of the resource on that beam. Line 31 shows Where both are the same. Line 32 is offset against 31 by the set quality offset qO which is here assumed to be a constant value. Said lines 31 and 32 is define regions I, II and III. In the region I, where qA for the dedicated RACH beam 21 is larger than qB for the common RACH beam 22, the dedicated RACH resources on beam 21 is selected. In region II, the quality metrics qB of the common RACH resources on beam 22 is larger than qA of the dedicated RACH resources beam 21. But it does not exceed it by the set quality offset qO. In other words, the decision in S4 of FIG. 4 would be “no” and accordingly still the dedicated RACH resources beam 21 in FIG. 1 will be selected.

In region III, the quality metrics qB of the common RACH resources on beam 22 exceeds the quality metrics qA of the dedicated RACH resources on beam 21 by the set quality offset qO or more. Then, the common RACH resources on beam 22 is selected and determined to be used. This corresponds to the “yes” decision in step S4 of FIG. 2.

Through the mentioned decision scheme, the dedicated RACH resources beam is prioritized over the common RACH resources beam in that it is selected for use even when exhibiting certain lower quality metrics. From a view point of overall network performs this may well be desirable because irrespective of the quality determinations, a dedicated RACH resources beam is less likely to encounter access conflicts with other UEs so that by the preference of the dedicated RACH resources beam, access conflicts and related signaling overhead and latency are avoided. To the contrary, if quality of the common RACH resources beam is much higher, as reflected by the set quality offset metrics qO, than that of a dedicated RACH resources beam, the method allows to use the common RACH resources beam, again in an attempt to increase overall network performance and user satisfaction.

As far as a method for comparative radio resource evaluation in mobile telecommunication is concerned, it comprises assessing a first quality metrics qA of an available dedicated RACH resource, assessing a second quality metrics qB of an available common RACH resource, obtaining a set quality offset metrics qO larger than zero, making a second determination if the second quality metrics exceeds the first by at least said set quality offset metrics qO and otherwise making a first determination.

A further method for comparative radio resource evaluation in mobile telecommunication comprises assessing a first quality metrics qA of dedicated RACH resources on a first beam, assessing a second quality metrics qB of common RACH resources on a second beam, obtaining an actual quality offset metrics qD amongst said assessed quality metrics qA, qB, and making determinations in accordance with said actual quality offset metrics qD. Said actual quality offset metrics qD may be obtained as a difference (qD=qB−qA) or as a ratio (qO=qB/qA) of said assessed=measured metrics qA, qB, or as another suitably scaled and formatted quantity relating to said assessed metrics qA, qB.

Said determinations may simply be to use and/or store and/or transmit the respective data as a data tuple, possibly for later evaluation or other use. They may be assessed, determined, stored, transmitted and evaluated periodically or triggered by certain events. Such data tuple may contain said first and/or second quality metrics qA, qB, their actual offset metrics qD (e. g. determined as qA−qB or qA/qB) and/or the obtained set quality offset metrics qO, date, time, location, possibly associated network resources and settings. Said data tuple may be used for immediate or later local or remote evaluation, e. g. for obtaining meaningful statistics, or may be used for immediate further measures or procedures such as the continuous adaptive or learning setting of network configuration parameters, the reconfiguration with sync, the managing of handovers or the like. The data not including the set quality offset metrics qO may be used for establishing the set quality offset metrics qO.

The various comparative evaluation results may be used for establishing comparative quality statistics for further use. Such statistics may be resolved in time and/or resolved in space/location/cell/beam. They can be established at an appropriately equipped station that receives the evaluation results. They can be established from the data tuple prepared and possibly transmitted as described above. The statistics can be used for setting network parameters, possibly time-dependent and/or depending on location/cell/beam.

A corresponding apparatus for comparative radio resource evaluation and radio resource management is also provided.

Features described in this specification claims shall be deemed combinable with other also if such a combination is not explicitly described, to the extent that the combination is technically feasible. Features described in a certain context or embodiment or figure or claim shall be considered separable from this context or embodiment or claim or figure, to the extent that it is technically feasible, and shall be is considered combinable with other figures or claims or embodiments or context, to the extent that it is technically feasible. Descriptions of method aspects shall be considered also as a description of related implementing means or devices, and vice versa.

### LIST OF REFERENCE NUMERALS

10 user equipment—UE
11, 12, 13, 14 stationary nodes
20 trajectory of user equipment
21 beam with dedicated RACH resources
22 beans with common RACH Resources
23 beam
24 broadcast area
S1-S7 method steps
31, 32 lines in diagram
qA quality metrics of dedicated RACH resources beam
qB quality metrics of common RACH resources beam
qD actual quality offset metrics
qO set quality offset metrics

1. Method for comparative radio resource evaluation, comprising the steps of:
assessing quality metrics of dedicated RACH resources carried by a beam and assessing quality metrics of common RACH resources carried by a beam,
comparatively evaluating said assessed quality metrics of said resources, and
storing or transmitting the comparative evaluation result or taking further measures in accordance with said comparative evaluation result.

2. The method of claim 1,
characterized in that
said assessing comprises:
assessing a first quality metrics qA of dedicated RACH resources carried by a first beam (21),
assessing a second quality metrics qB of corm Son RACH resources carried by a second beam (22),
said comparative evaluation comprises:
obtaining a set quality offset metrics qO, and
if the second quality metrics qB indicates a quality offset from said first quality metrics qA by at least said set quality offset metrics qO, making a second determination, and otherwise making a first determination.

3. The method of claim 2 comprising radio resource management for a handover procedure towards a target node in mobile telecommunication, wherein said radio resource management comprises the steps of:
a.) obtaining said set quality offset metrics qO as a value equal to or larger than zero, and
b.) making said second determination as using the common RACH resources and otherwise making said first determination as using the dedicated RACH resources.

4. The method of claim 2, wherein when no other determination is available a default determination is to use the dedicated RACH resources.

5. The method of claim 2, wherein the set quality offset metrics qO may be a predetermined absolute value or is a predetermined value relative to the first or the second quality metrics qA, qB, and/or is determined in accordance with network traffic and/or load balancing requirements.

6. The method of claim 2, wherein the set quality offset metrics qO is communicated from a node, preferably the target node, towards a user equipment, preferably together with RACH configuration information, preferably in a handover command message, and/or in a broadcast system information message.

7. The method according to claim 2, wherein the first and/or the second quality metrics qA, qB comprises an S/N ratio.

8. The method according to claim 2, wherein the first quality metrics qA is assessed from synchronization signal blocks (SSB) or from channel state information reference signals (CSI-RS).

9. The method according to claim 2, wherein the first quality metrics qA and/or second quality metrics qB and/or the set quality offset metrics qO is assessed in accordance with technical qualities and in accordance with other qualities.

10. The method according to claim 2, wherein the first quality metrics qA and/or second quality metrics qB and/or the set quality offset metrics qO is assessed in accordance with a movement of the concerned user equipment in relation to the respective beam.

11. The method according to claim 2, wherein the second quality metrics qB is assessed as a reference signal received power value (RSRP) and/or as a reference signal received quality value (RSRQ).

12. The method according to claim 2, characterized in that for said determination one of plural available quality metrics assessment methods is selected, and a corresponding plurality of available set quality offset metrics qO is provided for a corresponding selection of one of them.

13. The method according to claim 2, wherein the method is configured according to one or more 5G NR specifications.

14. The method according to claim 2, characterized in that the determination is made in the user equipment (10).

15. The method according to claim 2, characterized in that the determination is triggered by a handover command from a base station (11-14) or autonomously by a user equipment (10), preferable in accordance with one or more internal states or events or determinations of the user equipment (10), preferably upon reconfiguration with sync, and/or periodically.

16. The method according to claim 2, characterized in that the determination is used in a random access procedure by a user equipment (10) for establishing connectivity with a node (11-14) for sending implicit or explicit information from the user equipment (10) to the node (11-14) through the selected first beam (21) or second beam (22).

17. Apparatus for comparative radio resource evaluation in mobile telecommunication, comprising:
a memory storing processor-executable instructions, and
a processor arranged to execute the stored processor-executable instructions to perform operations of:
assessing quality metrics qA of dedicated RACH resources and quality metrics qB of common RACH resources, said resources carried by one or more beams,
making a comparative evaluation amongst said assessed quality metrics, and
storing and/or transmitting the comparative evaluation result and/or for taking further measures in accordance with said comparative evaluation result.

18. The apparatus of claim 17,
characterized in that
said assessing comprises
assessing a first quality metrics qA of dedicated RACH resources carried by a first beam (21),
assessing a second quality metrics qB of common RACH resources carried by a second beam (22),
said comparative evaluation means comprises
obtaining a set quality offset metrics qO, and
if the second quality metrics qB indicates a quality offset from said first quality metrics qA by at least said set quality offset metrics qO, making a second determination, and otherwise make a first determination.

19. The apparatus of claim 18 comprising radio resource management means for a handover procedure towards a target node in mobile telecommunication, wherein said radio resource management comprises the steps of:
a.) obtaining means configured to obtaining said set quality offset metrics qO as a value equal to or larger than zero, and
b.) making said second determination as using the common RACH resources and otherwise make said first determination as using the dedicated RACH resources.

20. (canceled)

21. A non-transitory data carrier holding executable code, the code, when running, implementing a method for comparative radio resource evaluation, the method comprising the steps of:
assessing quality metrics of dedicated RACH resources carried by a beam and assessing quality metrics of common RACH resources carried by a beam,
comparatively evaluating said assessed quality metrics of said resources, and
storing or transmitting the comparative evaluation result or taking further measures in accordance with said comparative evaluation result.
